(19) United States
(12) Patent Application Publication
(10) Pub. No.: US 2026/0210510 A1
(43) Pub. Date: Jul. 23, 2026

(54) LAMP FOR VEHICLE

(71) Applicant: SL Corporation, Daegu (KR)

(72) Inventor: Kae Hong KIM, Gyeongsan-si (KR)

(21) Appl. No.: 19/367,587

(22) Filed: Oct. 23, 2025

(30) Foreign Application Priority Data
Nov. 28, 2024 (KR) 10-2024-0173455

(51) Int. Cl. F21S 41/24; F21S 41/143; F21S 41/20

(52) U.S. Cl. CPC F21S 41/24; F21S 41/143; F21S 41/285

(57) ABSTRACT

A lamp for the vehicle includes a plurality of light sources arranged in a plurality of rows; a first lens including a plurality of guiding modules, each guiding module being configured to adjust a path of light emitted from each of the plurality of light sources; and a second lens through which the light emitted from the first lens transmits to form a predetermined beam pattern. Each of the plurality of guiding modules includes: a light-receiving portion onto which the light emitted from a corresponding light source among the plurality of light sources is incident; a light-transfer portion that transmits the light incident on the light-receiving portion; and a light-emitting portion that emits the light received from the light-transfer portion. The light-transfer portion includes at least one reflective surface that reflects the light incident on the light-receiving portion so as to cause it to be transmitted to the light-emitting portion.

### CROSS-REFERENCE TO RELATED APPLICATION

This application claims priority from Korean Patent Application No. 10-2024-0173455 filed on Nov. 28, 2024, which is incorporated herein by reference in its entirety.

### BACKGROUND

### 1. Technical Field

The present disclosure relates to a lamp for a vehicle and, more specifically, to a lamp for a vehicle that forms an optimal beam pattern while implementing a slim outer appearance design.

### 2. Description of Related Art

In general, a vehicle is provided with various types of lamps having an illumination function for more easily identifying an object located around the vehicle during low-light conditions (e.g., night-time driving) and a signaling function for notifying surrounding vehicles or a pedestrian of the driving state of the vehicle.

For example, a headlamp and a fog lamp are mainly used for the illumination functions, and a turn signal lamp, a tail lamp, and a brake lamp are mainly used for the signaling functions. Each lamp is stipulated by law in its installation standards and specifications so that each lamp may fully perform each function.

Recently, not only the functional aspect of helping safe driving by enabling the driver to secure visibility, which is the basic role of vehicle lamps, but also the aesthetic aspect of the outer appearance design have a great influence on purchase decisions for a vehicle.

To this end, research has been actively conducted to allow the vehicle lamp to have a slimmer outer appearance design and to form an optimal beam pattern.

### SUMMARY

A purpose to be achieved by the present disclosure is to provide a lamp for a vehicle capable of allowing light beams incident from a plurality of light sources to be reflected from at least one reflective surface so as to be emitted through a plurality of light-emitting portions arranged in a single row, thereby implementing a slimmer form factor and improving light efficiency.

The technical purposes of the present disclosure are not limited to those mentioned above, and other technical purposes not mentioned may be clearly understood by those skilled in the art from descriptions as set forth below.

In order to achieve the above purpose, according to one aspect of the present disclosure, a lamp for a vehicle may include a plurality of light sources arranged in a plurality of rows; a first lens including a plurality of guiding modules, each guiding module being configured to adjust a path of light emitted from each of the plurality of light sources; and a second lens through which the light emitted from the first lens transmits to form a predetermined beam pattern. Each of the plurality of guiding modules may include a light-receiving portion onto which the light emitted from a corresponding light source among the plurality of light sources is incident; a light-transfer portion that transmits the light incident on the light-receiving portion; and a light-emitting portion that emits the light received from the light-transfer portion. The light-transfer portion may include at least one reflective surface that reflects the light incident on the light-receiving portion so as to cause it to be transmitted to the light-emitting portion.

A central axis of the light-receiving portion may be spaced apart in a vertical direction from a central axis of the light-emitting portion.

The plurality of light sources may be arranged in a first row and a second row, each of which extends in a left-right direction, and the second row may be disposed below the first row. The plurality of guiding modules may include a first guiding module that adjusts a path of the light emitted from each of first light sources belonging to the first row among the plurality of light sources; and a second guiding module that adjusts a path of the light emitted from each of second light sources belonging to the second row among the plurality of light sources.

The first light sources and the second light sources may be arranged in a staggered manner along the left-right direction.

The first guiding module may include a first light-receiving portion onto which the light emitted from the first light source is incident; a first light-transfer portion that transmits the light incident on the first light-receiving portion; and a first light-emitting portion that emits the light received from the first light-transfer portion. The second guiding module may include a second light-receiving portion onto which the light emitted from the second light source is incident; a second light-transfer portion that transmits the light incident on the second light-receiving portion; and a second light-emitting portion that emits the light received from the second light-transfer portion. Each of the first light-transfer portion and the second light-transfer portion may include a first reflective surface that reflects the light incident to each of the first light-receiving portion and the second light-receiving portion and proceeding in a forward direction so as to cause it to proceed substantially in a vertical direction; and a second reflective surface that reflects the light reflected from the first reflective surface so as to cause it to proceed in the forward direction toward each of the first light-emitting portion and the second light-emitting portion.

A vertical position of a central axis of the first light-receiving portion may be higher than a vertical position of a central axis of the first light-emitting portion. Further, a vertical position of a central axis of the second light-receiving portion may be lower than a vertical position of a central axis of the second light-emitting portion.

At least one of the first reflective surface or the second reflective surface may include a plurality of reflective areas, and formation angles and/or curvatures of the plurality of reflective areas may be different.

The first lens may further include an additional reflective portion that reflects a portion of the light emitted from each of the plurality of guiding modules so as to cause it to proceed to the second lens, thereby allowing the beam pattern to be extended to one side. The additional reflective portion may be formed to extend from a bottom of the light-emitting portion of each of the plurality of guiding modules in a forward direction.

The light-emitting portions of the plurality of guiding modules may be arranged in a single row that extends in a direction parallel to rows in which the plurality of light sources are arranged.

Both opposing sides of the light emitting portion of at least one of the plurality of guiding modules may be formed asymmetrically with each other with respect to a central axis of the light emitting portion.

The beam pattern may include a plurality of pattern areas respectively formed by the plurality of guiding modules, and an optical pattern may be formed in the light-emitting portion of at least one of the plurality of guiding modules to control a corresponding pattern area among the plurality of pattern areas. An orientation of the optical pattern formed in at least one of the plurality of guiding modules may be different from an orientation of the optical pattern formed in at least another of the plurality of guiding modules.

Central axes of the light-emitting portions of different guiding modules of the plurality of guiding modules may be tilted at different angles with respect to a reference line parallel to an optical axis of the second lens. The tilting angle of the central axis of the light-emitting portion of the guiding module may increase as a lateral spacing between the optical axis of the second lens and the central axis of the light-emitting portion of the guiding increases.

The light-emitting portions of at least two different guiding modules among the plurality of guiding modules may be disposed to be spaced by different distances from respective light sources among the plurality of light sources. The distances between the light-emitting portion and the respective light source may increase as a lateral spacing between the light-emitting portion and an optical axis of the second lens increases.

The second lens may include a light-receiving surface and a light-emitting surface. A light-receiving optical pattern may be formed in at least a portion of the light-receiving surface, and a light-emitting optical pattern may be formed in at least a portion of the light-emitting surface. The light-receiving optical pattern may be formed in the entire light-receiving surface, and the light-emitting optical pattern may be formed in a portion of the light-emitting surface. Further, an orientation of the light-receiving optical pattern may be different from an orientation of the light-emitting optical pattern.

Other features of the present disclosure are included in the detailed description and drawings.

According to the lamp for the vehicle of the present disclosure as described above, one or more of the following effects can be provided.

Each light-receiving portion on which the light from each of the plurality of light sources is incident may have a high degree of concentration. Even when the light-receiving portion has a relatively large size, the light beams from the light-receiving portions may be reflected from at least one reflective surface so as to proceed to the plurality of light-emitting portions arranged in a single row. Accordingly, light efficiency may be improved, and a slimmer form factor may be implemented.

The effects of the present disclosure are not limited to those mentioned above, and other effects not mentioned will be clearly understood by those skilled in the art from the description of the claims.

### BRIEF DESCRIPTION OF THE DRAWINGS

The above and other aspects and features of the present disclosure will become more apparent by describing in detail illustrative embodiments thereof with reference to the attached drawings, in which:

FIGS. 1 and 2 are perspective views showing a lamp for a vehicle according to an embodiment of the present disclosure;

FIG. 3 is a plan view illustrating a lamp for a vehicle according to an embodiment of the present disclosure;

FIG. 4 is a cross-sectional view taken along a line A-A′ of FIG. 3;

FIG. 5 is a cross-sectional view taken along a line B-B′ of FIG. 3;

FIG. 6 is a schematic diagram illustrating a beam pattern formed by a lamp for a vehicle according to an embodiment of the present disclosure;

FIG. 7 is a cross-sectional view illustrating a first guiding module according to an embodiment of the present disclosure;

FIG. 8 is a cross-sectional view illustrating a second guiding module according to an embodiment of the present disclosure;

FIG. 9 is a front view showing a first lens according to an embodiment of the present disclosure;

FIG. 10 is a schematic diagram illustrating a path of light reflected from an additional reflective portion according to an embodiment of the present disclosure;

FIG. 11 is a schematic diagram illustrating an extended area formed by light reflected from the additional reflective portion of FIG. 10;

FIG. 12 is a schematic diagram illustrating a central axis of a plurality of guiding modules according to an embodiment of the present disclosure;

FIG. 13 is a schematic diagram illustrating a formation length of a plurality of guiding modules according to an embodiment of the present disclosure;

FIG. 14 is a front view showing a second lens according to an embodiment of the present disclosure; and

FIG. 15 is a rear view showing a second lens according to an embodiment of the present disclosure.

### DETAILED DESCRIPTION

Advantages and features of the present disclosure and methods of accomplishing the same may be understood more readily by reference to the following detailed description of exemplary embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims. Throughout the specification, like reference numerals in the drawings denote like elements.

In some embodiments, well-known steps, structures and techniques will not be described in detail to avoid obscuring the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Embodiments of the disclosure are described herein with reference to plan and cross-section illustrations that are schematic illustrations of exemplary embodiments of the invention. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing. In the drawings, respective components may be enlarged or reduced in size for convenience of explanation.

Hereinafter, the present disclosure will be described with reference to drawings for illustrating a lamp for a vehicle according to embodiments of the present disclosure.

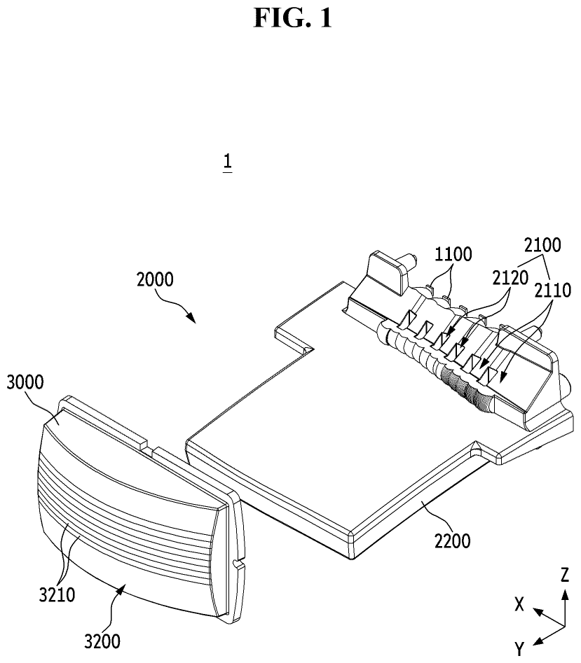

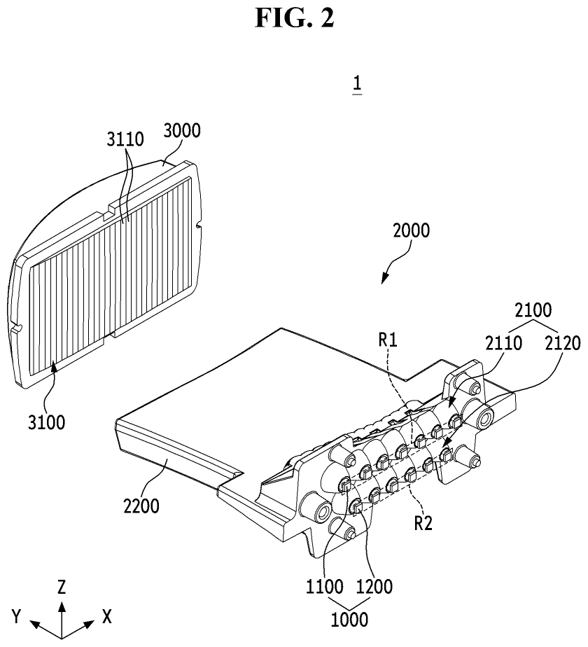

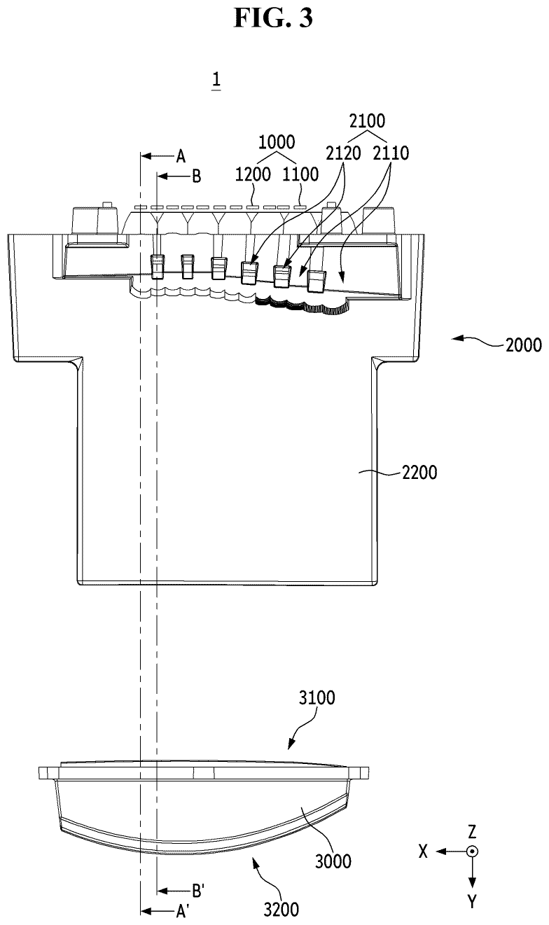

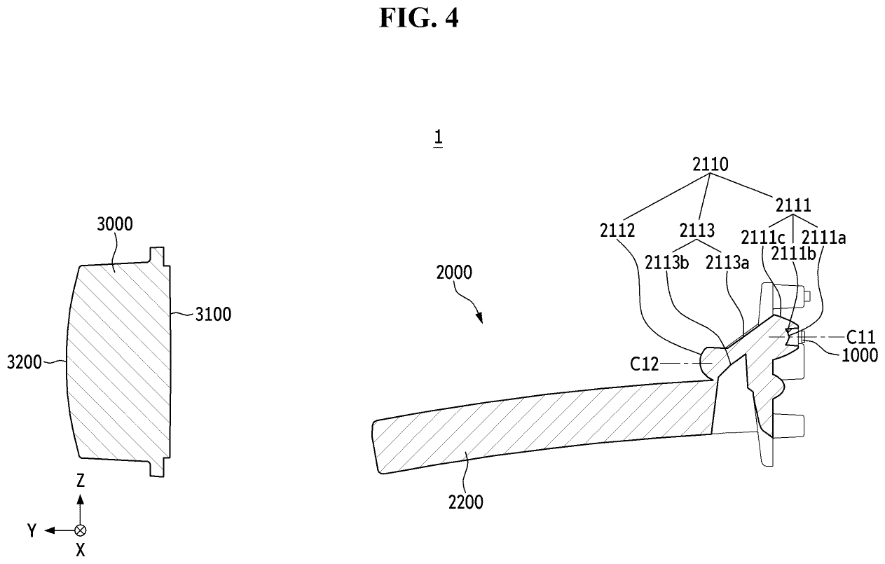

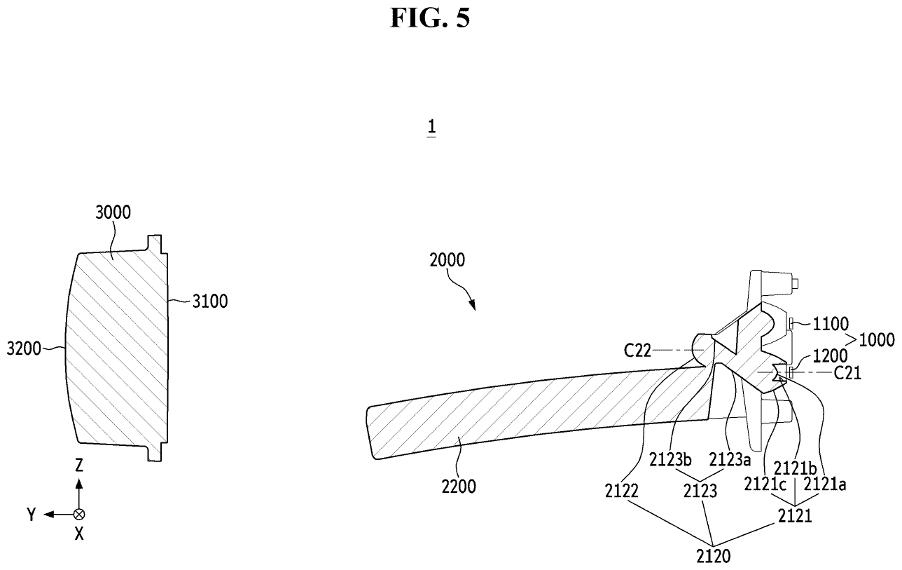

FIGS. 1 and 2 are perspective views illustrating a lamp for a vehicle according to an embodiment of the present disclosure, FIG. 3 is a plan view illustrating the lamp for a vehicle according to an embodiment of the present disclosure, FIG. 4 is a cross-sectional view taken along a line A-A′ of FIG. 3, and FIG. 5 is a cross-sectional view taken along a line B-B′ of FIG. 3.

Referring to FIGS. 1 to 5, a lamp 1 for a vehicle according to an embodiment of the present disclosure may include a plurality of light sources 1000, a first lens 2000, and a second lens 3000. A case in which an X-axis means a vehicle width direction as a left-right direction (e.g., lateral direction), a Y-axis means a driving direction as a front-rear direction (e.g., longitudinal direction), and a Z-axis means a vehicle height direction as a vertical direction will be described by way of example. However, the present disclosure is not limited thereto, and the directions that the X-axis, the Y-axis, and the Z-axis actually mean may vary depending on a position at or an orientation in which the lamp 1 for a vehicle of the present disclosure is installed.

In an embodiment of the present disclosure, a case in which the lamp 1 for a vehicle is used as a head lamp for securing a front view of a vehicle by irradiating light in a proceeding direction of the vehicle when the vehicle is operated at low-light conditions (e.g., night or in a tunnel) will be described. However, the present disclosure is not limited thereto, and the lamp 1 for a vehicle of the present disclosure may be used not only for a head lamp but also for various lamps installed in the vehicle, such as a tail lamp, a brake lamp, a daytime running lamp, a turn signal lamp, a fog lamp, a backup lamp, a position lamp, and the like. The lamp 1 for a vehicle of the present disclosure may be used for any one of the above-described various purposes or may be used for two or more purposes.

When the lamp 1 for a vehicle according to the present disclosure is used as a head lamp, the lamp 1 for a vehicle may form at least one of a low beam pattern or a high beam pattern. The low beam pattern may secure a wider field of view within a short distance in front of the vehicle by irradiating light to an area under the cut-off line so that glare does not occur to a driver of a vehicle in front of the present vehicle, such as a preceding vehicle or an opposing vehicle. The high beam pattern may be at least partially disposed in an area above the cut-off line for securing a longer field of view in front of the vehicle. In general, when the high beam pattern is formed, the low beam pattern is formed together therewith to ensure a wide field of view in a short distance in front of the vehicle and a long field of view in a long distance in front of the vehicle.

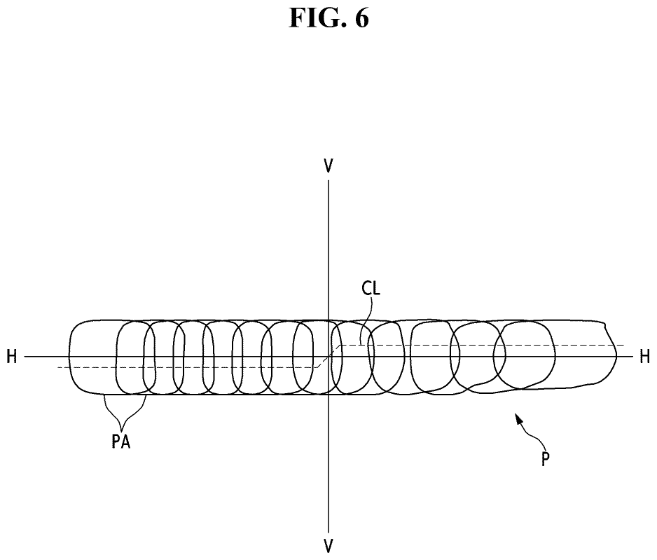

Hereinafter, in an embodiment of the present disclosure, a case in which the vehicle lamp 1 according to the present disclosure forms a high beam pattern P in which at least a portion thereof is disposed above the cut-off line CL as shown in FIG. 6 will be described by way of example. In this regard, a case in which the high beam pattern P of FIG. 6 is a beam pattern formed by light irradiated on a screen disposed at a predefined distance in front of the vehicle will be described by way of example.

The high beam pattern P may include a plurality of pattern areas PA formed by light beams respectively emitted from the plurality of light sources 1000. At least one of the plurality of light sources 1000 may be turned off based on the position of a front vehicle to form a shadow area so that glare does not occur toward the driver of that vehicle.

The plurality of light sources 1000 may be installed on a common substrate and be arranged in at least one row R1 and R2, each row extending in the left-right direction. In an embodiment of the present disclosure, an example in which the plurality of light sources 1000 are arranged in a first row R1 and a second row R2 disposed above the first row R1 will be described by way of example.

In this regard, a case in which a semiconductor light emitting device such as a light emitting diode (LED) is used as each of the plurality of light sources 1000 will be described by way of example. However, embodiments of the present disclosure are not limited thereto, and various types of light sources such as a bulb or a laser diode (LD) as well as the light emitting diode (LED) may be used as each of the plurality of light sources 1000. Optical elements such as a reflector, a phosphor, a mirror, a prism, and the like may be additionally used for adjusting a path, brightness, color, and the like of light according to the type of the light source.

In addition, the plurality of light sources 1000 being installed on one common substrate may be understood that optical axes of the plurality of light sources 1000 are parallel to one another.

In an embodiment of the present disclosure, a case in which the plurality of light sources 1000 are arranged in the two rows R1 and R2 are will be described by way of example. However, this is merely an example for helping understanding of the present disclosure, and the number of rows that the plurality of light sources 1000 form is not limited thereto, and may be variously changed according to light distribution characteristics required in a beam pattern to be formed by the vehicle lamp 1 of the present disclosure, a layout of the vehicle lamp 1 of the present disclosure, or the like. The light distribution characteristics may include a position, a size, a shape, brightness, or the like of an area to which the light is irradiated.

Among the plurality of light sources 1000, the light sources 1100 belonging to the first row R1 and the light sources 1200 belonging to the second row R2 may be arranged in a staggered manner along the left-right direction, and this arrangement may allow the plurality of pattern areas PA to be arranged in a staggered manner as shown in FIG. 6 described above.

Hereinafter, in an embodiment of the present disclosure, each of the light sources 1100 belonging to the first row R1 among the plurality of light sources 1000 will be collectively referred to as a “first light source”, and each of the light sources 1200 belonging to the second row R2 among the plurality of light sources 1000 will be collectively referred to as a “second light source”.

The first lens 2000 may be disposed in front of the plurality of light sources 1000 and be configured to adjust a path of light so that the light emitted in a forward direction from each of the plurality of light sources 1000 proceeds to the second lens 3000 disposed in front of the first lens 2000.

In an embodiment of the present disclosure, the configuration where the first lens 2000 is disposed in front of the plurality of light sources 1000 and the second lens 3000 is disposed in front of the first lens 2000 is an example of a case in which the direction of light emission from the vehicle lamp 1 of the present disclosure is assumed to be the forward direction. The direction actually meant by the forward direction may vary according to the installation position and/or direction of the vehicle lamp 1 of the present disclosure.

The first lens 2000 may include a plurality of guiding modules 2100 for adjusting a path of light beams respectively emitted from the plurality of light sources 1000. The plurality of guiding modules 2100 may be integrally formed with one another.

In an embodiment of the present disclosure, an example in which the first light sources 1100 and the second light sources 1200 are arranged in the staggered manner along the left-right direction is described. Thus, a case in which the guiding modules 2110 corresponding to the first light sources 1100 and the guiding modules 2120 corresponding to the second light sources 1200 are arranged in the staggered manner along the left-right direction is also described by way of example. Hereinafter, the guiding module 2110 corresponding to the first light source 1100 will be collectively referred to as a “a first guiding module”, and the guiding module 2120 corresponding to the second light source 1200 will be collectively referred to as a “second guiding module”.

The first guiding module 2110 may include a first light-receiving portion 2111, a first light-emitting portion 2112, and a first light-transfer portion 2113.

The first light-receiving portion 2111 may include a central surface 2111a having a central axis C11 coinciding with the optical axis of the first light source 1100, a protruding surface 2111b that protrudes from the periphery of the central surface 2111a toward the first light source 1100, and a reflective surface 2111c that reflects the light incident on the protruding surface 2111b toward the forward direction.

The first light-emitting portion 2112 may allow the light incident on the first light-receiving portion 2111 and then transmitted through the first light-transfer portion 2113 to be emitted therethrough, and may have a convex shape in the forward direction for condensing the emitted light.

In an embodiment of the present disclosure, a central axis C11 of the first light-receiving portion 2111 and a central axis C12 of the first light-emitting portion 2112 may be parallel to the front-rear direction. The central axis C11 of the first light-receiving portion 2111 may be spaced apart from the central axis C12 of the first light-emitting portion 2112 and be disposed above the central axis C12. This configuration may improve light efficiency and enable a slimmer outer appearance design, and a detailed description thereof will be provided later below.

The first light-transfer portion 2113 may serve to allow the light incident on the first light-receiving portion 2111 to be reflected therefrom at least once or more and then transmitted to the first light-emitting portion 2112.

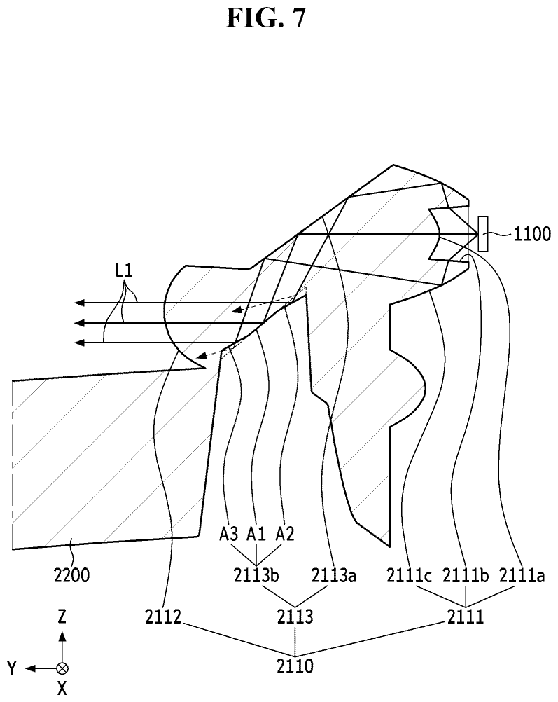

As shown in FIG. 7, the first light-transfer portion 2113 may include a first reflective surface 2113a that reflects the light L1 incident to the first light-receiving portion 2111 and traveling in the forward direction so as to cause it to travel substantially in the vertical direction, and a second reflective surface 2113b that reflects the light reflected from the first reflective surface 2113a so as to cause it to travel in the forward direction toward the first light-emitting portion 2112. The first reflective surface 2113a may be formed to be inclined frontwards downwardly, that is, toward the central axis C12 of the first light-emitting portion 2112 as the first reflective surface extends from a rear end to a front end. The second reflective surface 2113b may be formed to be inclined rearwards upwardly, that is, toward the central axis C11 of the first light-receiving portion 2111 as the second reflective surface extends from a front end to a rear end.

In addition, the second reflective surface 2113b may be disposed closer to the first light-emitting portion 2112 than the first reflective surface 2113a, so that the light reflected from the first reflective surface 2113a is reflected from the second reflective surface 2113b and proceeds toward the first emitting portion 2112.

In this regard, the first light-transfer portion 2113 may be configured such that at least one of the first reflective surface 2113a or the second reflective surface 2113b includes a plurality of reflective areas A1, A2, and A3 having different reflective characteristics. The plurality of reflective areas A1, A2, and A3 having the different reflective characteristics may be understood as having different formation angles and/or curvatures, and thus traveling directions and/or concentrations of light thereof are different from one another.

In an embodiment of the present disclosure, a case in which the second reflective surface 2113a of the first light-transfer portion 2113 includes a plurality of reflective areas A1, A2, and A3 having different reflective characteristics will be described by way of example. If the second reflective surface 2113b had a flat shape, a portion of the light reflected from the second reflective surface 2113b might deviate from the direction toward the first light-emitting portion 2112 as indicated by dotted arrows, potentially causing light loss. For this reason, the second reflective surface 2113a of the first light-transfer portion 2113 may include a plurality of reflective areas A1, A2, and A3 having different reflective characteristics, to allow the light reflected from the second reflective surface 2113b to be emitted through the first light-emitting portion 2112 and proceed to the second lens 3000 with minimal loss, thereby improving light efficiency.

The second guiding module 2120 may include a second light-receiving portion 2121, a second light-emitting portion 2122, and a second light-transfer portion 2123.

Similar to the first light-receiving portion 2111, the second light-receiving portion 2121 may include a central surface 2121a having a central axis C21 that coincides with the optical axis of the second light source 1200, a protruding surface 2121b that protrudes from the periphery of the central surface 2121a toward the second light source 1200, and a reflective surface 2121c that reflects the light incident on the protruding surface 2121a therefrom so as to cause it to travel in the forward direction.

The second light-emitting portion 2122 may receive the light incident on the second light-receiving portion 2121 and then transmitted through the second light-transfer portion 2123, and emit the received light. The second light-emitting portion 2122 may have a convex shape in the forward direction for condensing the emitted light.

In an embodiment of the present disclosure, the central axis C21 of the second light-receiving portion 2121 may be disposed below the central axis C22 of the second light-emitting portion 2122 and be spaced apart from the central axis C22 of the second light-emitting portion 2122. This configuration is indented to improve light efficiency and implement a slimmer appearance design, and a detailed description thereof will be described later below.

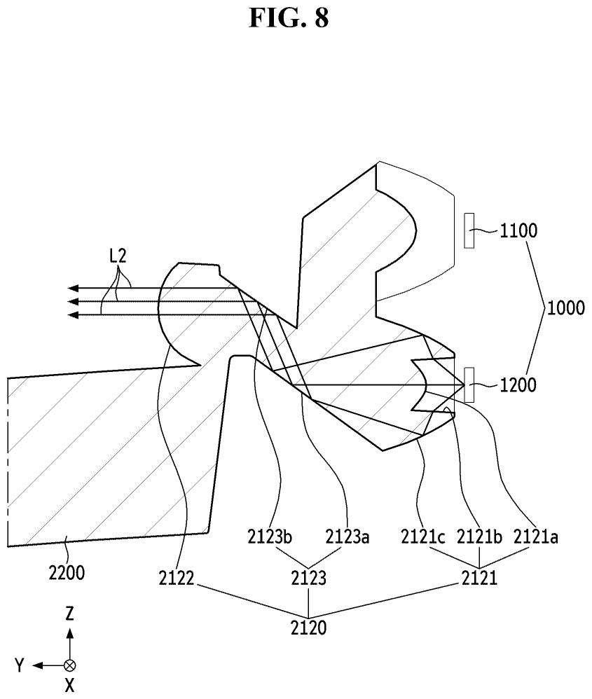

As shown in FIG. 8, the second light-transfer portion 2123 may include a first reflective surface 2123a that reflects light L2 incident on the second light-receiving portion 2121 and traveling in the forward direction so as to cause it to travel substantially in the vertical direction, and a second reflective surface 2123b that reflects the light reflected from the first reflective surface 2123a so as to cause it to travel in the forward direction toward the second light-emitting portion 2122. The first reflective surface 2123a may be formed to be inclined frontwards and upwardly, that is, in a direction toward the central axis C22 of the second light-emitting portion 2122 as the first reflective surface extends from the rear end to the front end. The second reflective surface 2123b may be formed to be inclined rearwards downwardly, that is, in a direction toward the central axis C21 of the second light-receiving portion 2121 as the second reflective surface extends from the front end to the rear end.

In addition, the second reflective surface 2123b may be disposed closer to the second light-emitting portion 2122 than the first reflective surface 2123a, so that the light reflected from the first reflective surface 2123a is reflected from the second reflective surface 2123b and proceeds toward the second light-emitting portion 2122.

In this regard, in a similar manner as the first light-transfer portion 2113 described above, the second light-transfer portion 2123 may be configured such that at least one of the first reflective surface 2123a or the second reflective surface 2123b includes a plurality of reflective areas having different reflective characteristics, to allow the light reflected from the second reflective surface 2123b to be emitted through the second light-emitting portion 2122 with minimal loss.

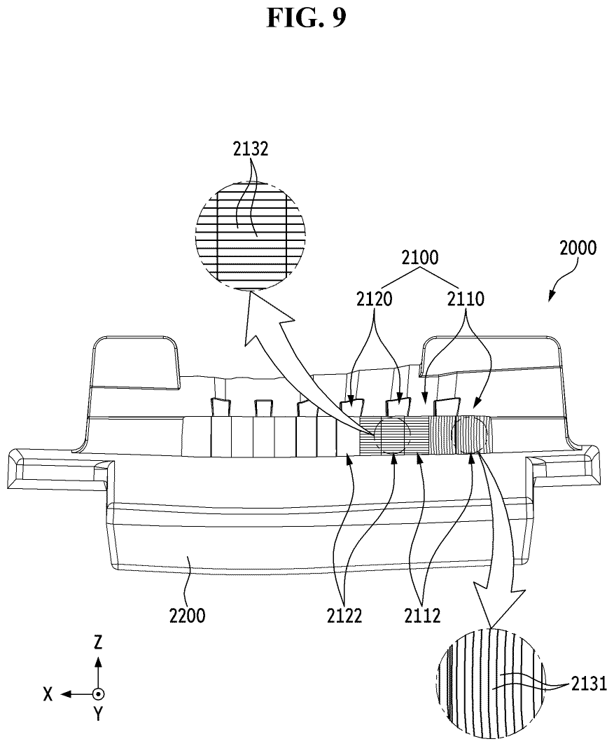

The first light-emitting portion 2112 of the first guiding module 2110 and the second light-emitting portion 2122 of the second guiding module 2120 may be arranged in a single row that extends in a direction in which each of the first row R1 and the second row R2 of the plurality of light sources 1000 extends, that is, in the left-right direction, as shown in FIG. 9. Thus, the collection of the light beams respectively emitted from the first light sources 1100 belonging to the first row R1 and the collection of the light beams respectively emitted from the second light sources 1200 belonging to the second row R2 may be respectively emitted through the first light-emitting portion 2112 and the second light-emitting portion 2122 arranged in the single row. Thus, the slim outer appearance design of the lamp may be achieved, and the light efficiency may be improved due to the high degree of concentration of each of the first light-receiving portion 2111 and the second light-receiving portion 2121 having a total internal reflection (TIR) structure.

In other words, the TIR structure may have a high degree of concentration but may also have a relatively large size. Accordingly, it may be more difficult to implement a slim design. However, in an embodiment of the present disclosure, the light incident on the first light-receiving portion 2111 and the light incident on the second light-receiving portion 2121 may be respectively reflected from the first reflective surfaces 2113a and 2123a and then the second reflective surfaces 2113b and 2123b and may subsequently be respectively emitted through the first light-emitting portion 2112 and the second light-emitting portion 2122, which are arranged in a single row. Consequently, the light efficiency may be improved due to the high degree of concentration, and a slimmer form factor may be achieved due to the single row arrangement.

As described above, the light incident on the respective light-receiving portions 2111 and 2121 of the plurality of guiding modules 2100 may be guided by the respective light-transfer portions 2113 and 2123 so as to be transmitted to the respectively light-emitting portions 2112 and 2122, which are spaced apart from each of the light-receiving portions 2111 and 2121 in the vertical direction. As the light-emitting portions 2112 and 2122 of the plurality of guiding modules 2100, 2110, and 2120 are arranged in a single row, a slim outer appearance design can be implemented.

In this regard, as shown in FIG. 9, optical patterns 2131 and 2132 may be formed in at least one of the light-emitting portions 2112 or 2122 of the plurality of guiding modules 2100. This configuration is intended to control a shape of at least one of the plurality of pattern areas PA as shown in FIG. 6.

For example, the optical patterns 2131 may be formed in the light-emitting portion of one of the plurality of guiding modules 2100 by extending in the vertical direction and being arranged in a horizontal direction. In this regard, the dimension in the left-right direction (e.g., width) of at least one pattern area among the plurality of pattern areas PA may be controlled.

In addition, the optical patterns 2132 may be formed in the light-emitting portion of another of the plurality of guiding modules 2100 by extending in the horizontal direction and being arranged in the vertical direction. In this regard, the dimension in the vertical direction (e.g., height) of at least one pattern area among the plurality of pattern areas PA may be controlled.

In other words, when the direction in which the optical patterns 2131 formed in one of the plurality of guiding modules 2100 extend and the direction in which the optical patterns 2132 formed in another thereof extend are different from each other, the dimensions in different directions of the corresponding pattern areas among the plurality of pattern areas PA may be controlled to form an optimal beam pattern.

In an embodiment of the present disclosure, a case in which the optical pattern formed in the light-emitting portion of one of the plurality of guiding modules 2100 and the optical pattern formed in the light-emitting portion of another of the plurality of guiding modules 2100 are formed in different directions is described by way of example. However, embodiments of the present disclosure are not limited thereto, and the direction in which the optical pattern is formed in at least one of the plurality of guiding modules 2100 may be variously changed based on the light distribution characteristics of each of the plurality of pattern areas PA to be formed in the vehicle lamp 1 of the present disclosure.

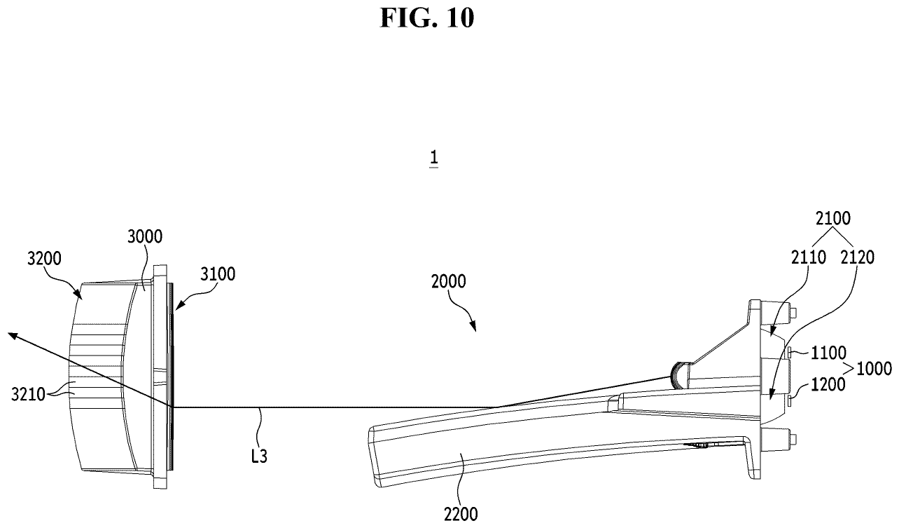

As shown in FIG. 10, the first lens 2000 may further include an additional reflective portion 2200 that reflects a portion of light L3 emitted from at least one of the plurality of guiding modules 2100 so as to cause it to travel upward in the forward direction. The additional reflective portion 2200 may be formed to extend in the forward direction from bottoms of the light-emitting portions 2112 and 2122 of the plurality of guiding modules 2100.

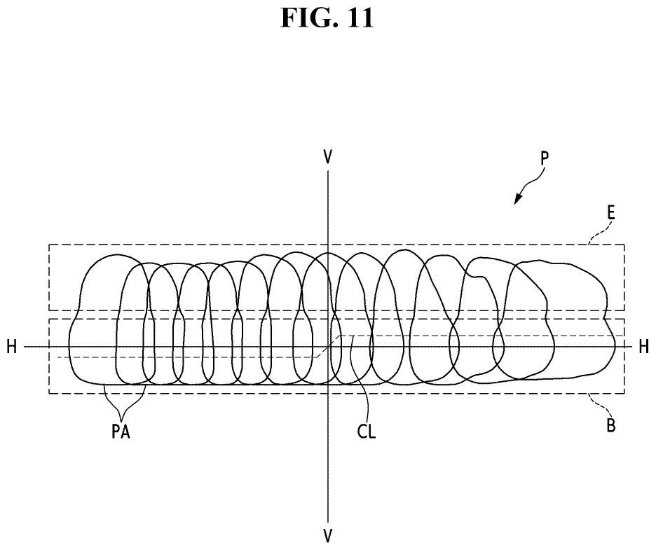

The additional reflective portion 2200 may serve to reflect a portion of the light emitted from at least one of the first light-emitting portion 2112 or the second light-emitting portion 2122 so as to cause it to travel in the forward and upward direction. The light reflected from the additional reflective portion 2200 may form an extension area E, which upwardly extends from an upper end of the high beam pattern P as shown in FIG. 11.

In other words, each of the plurality of pattern areas PA of the high beam pattern P may include a base area B, which is formed by the light emitted from the first light-emitting portion 2112 and the second light-emitting portion 2122 and directly incident on the second lens 3000, and the extension area E, which is formed by the light reflected from the additional reflective portion 2200. Accordingly, the front viewing distance can be improved.

In an embodiment of the present disclosure, a case in which a curvature of the additional reflective portion 2200 increases as the additional reflective portion 2200 extends toward a front end thereof will be described by way of example. However, this configuration is only an example for helping understanding of the present disclosure, and the present disclosure is not limited thereto. In another example, the additional reflective portion 2200 may be formed to have a uniform curvature in an area between a front end and a rear end thereof, or may be formed to have different curvatures in different areas depending on the traveling path of the light reflected from the additional reflective portion 2200.

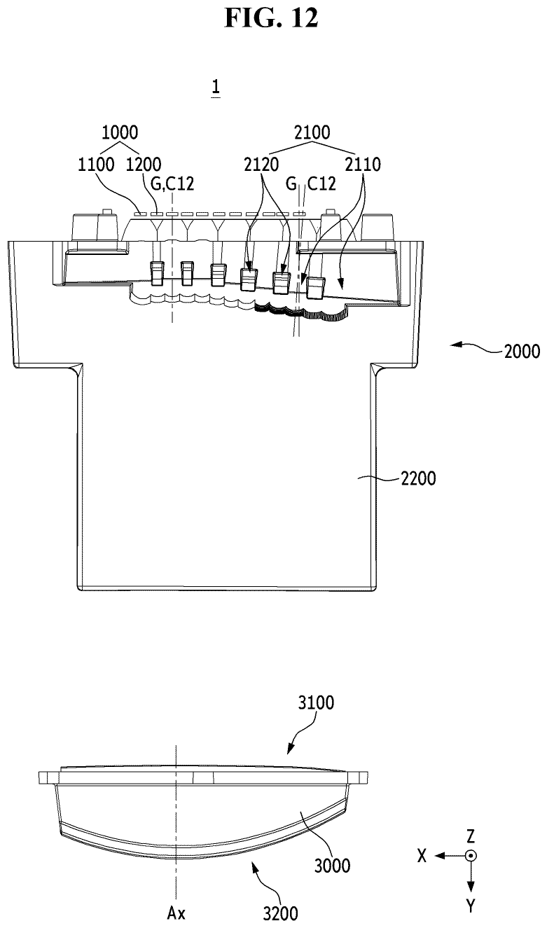

As shown in FIG. 12, the lamp 1 for a vehicle according to the present disclosure may be formed such that at least one of the plurality of guiding modules 2100 is laterally tilted at a predetermined angle with respect to a reference line G parallel to an optical axis Ax of the second lens 3000.

In other words, the central axis C12 of the light-emitting portion of the guiding module disposed proximate to the optical axis Ax of the second lens 3000 among the plurality of guiding modules 2100 may be disposed parallel to the reference line G. In contrast, the central axis C12 of the light-emitting portion of the guiding module disposed relatively distant from the optical axis Ax of the second lens 3000 among the plurality of guiding modules 2100 may be tilted in a direction toward the optical axis Ax of the second lens 3000 at a predetermined angle with respect to the reference line G. Thus, a situation in which the light emitted from the guiding module disposed further away from the optical axis Ax of the second lens 3000 fails to be incident on the lens 3000 and causes the light loss may be prevented. In this regard, the direction and the angle at which the central axis of the light-emitting portion of each of the plurality of guiding modules 2100 is tilted with respect to the reference line G may be variously changed depending on the size of the second lens 3000 and/or the position of each of the plurality of guiding modules 2100.

Although FIG. 12 illustrates an example in which the central axis C12 of the first light-emitting portion 2112 of the first guiding module 2110 among the plurality of guiding modules 2100 is tilted relative to the reference line G, this configuration is to help understanding of the present disclosure, and the present disclosure is not limited thereto. Similar configuration may be applied to the central axis C22 of the second light-emitting portion 2122 of the second guiding module 2120.

In this regard, in FIG. 12, a case in which the light-emitting portion of at least one of the plurality of guiding modules 2100 is tilted at a predetermined angle with respect to the optical axis Ax of the second lens 3000 so that the light emitted from the plurality of guiding modules 2100 is incident on the second lens 3000 with minimal loss is described by way of example. In addition, both opposing sides (e.g., halves) of the light-emitting portion of at least one of the plurality of guiding modules 2100 may be formed to be asymmetric with each other around the central axis thereof so that the light emitted from the plurality of guiding modules 2100 may be incident on the second lens 3000 with minimal loss.

In an embodiment of the present disclosure, a description that both opposing sides of the light-emitting portion of at least one of the plurality of guiding modules 2100 are formed to be asymmetric with each other with respect to the central axis thereof may mean that the lateral curvatures of the both sides opposing each other with respect to the central axis are different from each other. Thus, the light emitted from the guiding module that is laterally spaced apart from the optical axis Ax of the second lens 3000 among the plurality of guiding modules 2100 by a relatively greater spacing may be refracted by a greater angle. Thus, the light emitted from the guiding module laterally spaced apart from the optical axis Ax of the second lens 3000 among the plurality of guiding modules 2100 by a relatively greater spacing may also be incident on the second lens 3000.

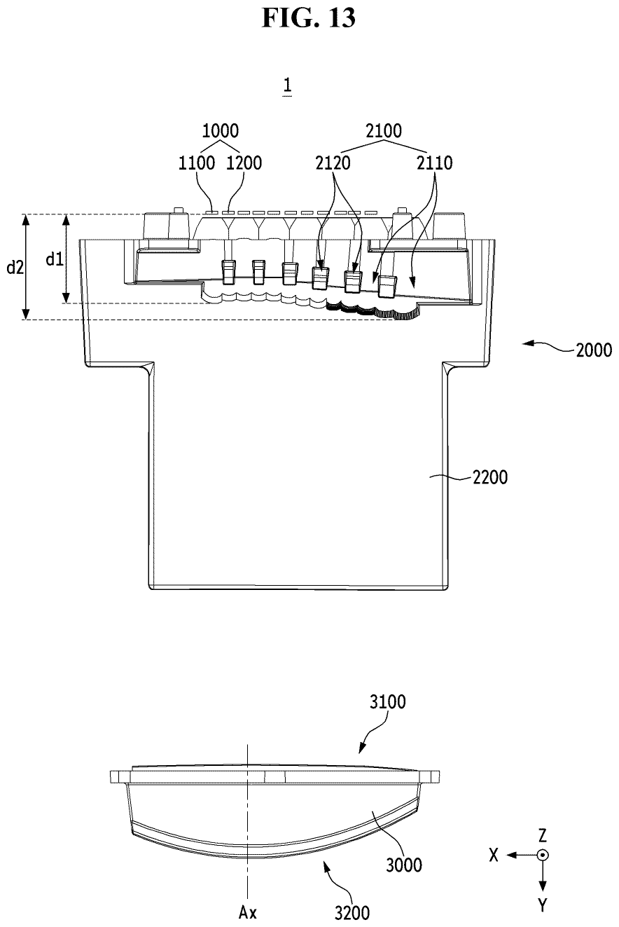

In addition, as shown in FIG. 13, in the lamp 1 for a vehicle according to the present disclosure, a spacing in the front-rear direction between the light-emitting portion of one of the plurality of guiding modules 2100 and a corresponding light source may be different from a spacing in the front-rear direction between the light-emitting portion of another of the plurality of guiding modules 2100 and a corresponding light source.

In other words, the distance between the light-emitting portion of the guiding module disposed laterally farther from the optical axis Ax of the second lens 3000 among the plurality of guiding modules 2100 and the corresponding light source may be greater. In an embodiment of the present disclosure, since the plurality of light sources 1000 are installed on a common substrate, as the distance between the light-emitting portion of the guiding module disposed laterally farther from the optical axis Ax of the second lens 3000 among the plurality of guiding modules 2100 and the corresponding light source is greater, the light-emitting portion may be disposed more forward.

In this regard, a distance d2 between the light-emitting portion of the guiding module disposed laterally farther from the optical axis Ax of the second lens 3000 among the plurality of guiding modules 2100 and a corresponding light source may be greater than a distance d1 between the light-emitting portion of the guiding module disposed laterally closer to the optical axis Ax of the second lens 3000 among the plurality of guiding modules 2100 and a corresponding light source. This configuration may compensate for a size reduction of the pattern area formed by the light emitted from the guiding module disposed laterally farther from the optical axis Ax of the second lens 3000. In other words, the distance between the light-emitting portion of the guiding module disposed laterally farther from the optical axis Ax of the second lens 3000 among the plurality of guiding modules 2100 and a corresponding light source may be greater, such that the size of the pattern area formed by the light emitted from the guiding module disposed laterally farther from the optical axis Ax of the second lens 3000 may be increased, thereby allowing a pattern area to be formed having an appropriate size.

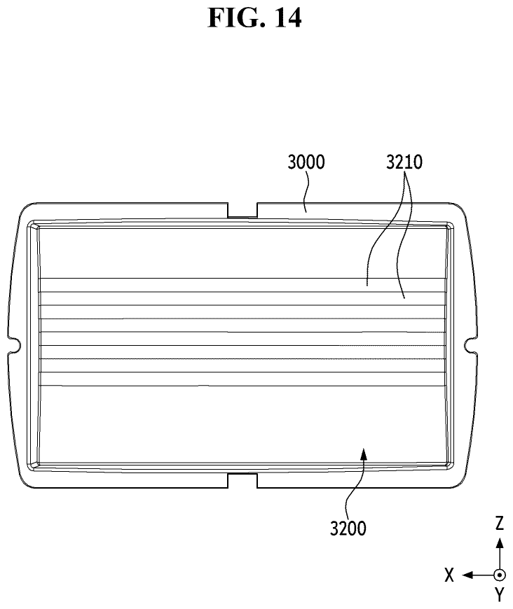

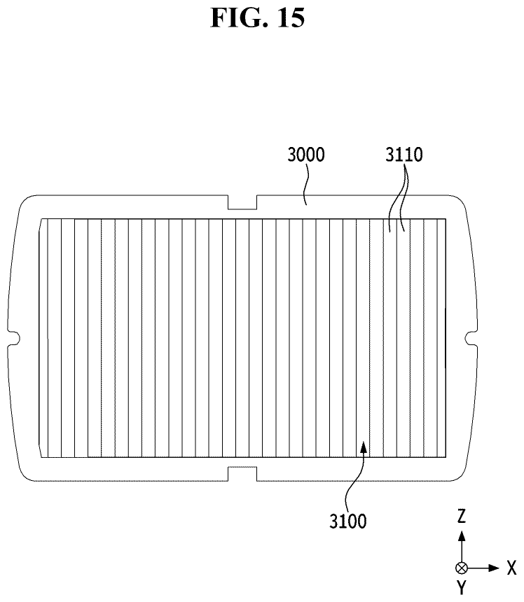

FIG. 14 is a front view illustrating a second lens according to an embodiment of the present disclosure, and FIG. 15 is a rear view illustrating a second lens according to an embodiment of the present disclosure.

Referring to FIGS. 14 and 15, the second lens 3000 according to an embodiment of the present disclosure may serve to allow the light emitted from the first lens 2000 to be transmitted therethrough to form the high beam pattern P as described above with reference to FIGS. 6 and 11. In an embodiment of the present disclosure, a case in which a light-emitting surface 3200 of the second lens is formed to have a greater curvature than the curvature of a light-receiving surface 3100 of the second lens so that the concentration of the light emitted from the second lens 3000 is improved is described by way of example. However, the present disclosure is not limited thereto, and the curvature of each of the light-receiving surface 3100 and the light-emitting surface 32000 may be variously changed depending on the light distribution characteristics of the beam pattern to be formed by the lamp 1 for a vehicle.

In this regard, a case in which the refractive power of the first lens 2000, that is, the light-emitting portions 2112 and 2122 of the plurality of guiding modules 2100 is greater than the refractive power of the second lens 3000 so that the light emitted from the first lens 2000 may be incident on the second lens 3000 with minimal loss will be described by way of example. This configuration is advantageous because the larger the refractive power of the first lens 2000, the slimmer the second lens 3000 may be.

In addition, in an embodiment of the present disclosure, at least one of the light-receiving surface 3100 or the light-emitting surface 3200 of the second lens 3000 may be formed such that a partial area thereof has a curvature different from the curvature of another partial area. However, the present disclosure is not limited thereto, and the curvature of each of the light-receiving surface 3100 and the light-emitting surface 3200 of the second lens 3000 may be variously changed based on the light distribution characteristics of the beam pattern to be formed by the lamp 1 for a vehicle of the present disclosure.

In the above-described second lens 3000, a light-receiving optical pattern 3110 may be formed in at least a portion of the light-receiving surface 3100, and a light-emitting optical pattern 3210 may be formed in at least a portion of the light-emitting surface 3200.

In the second lens 3000 according to an embodiment of the present disclosure, a case in which the light-receiving optical pattern 3110 is formed on the entire light-receiving surface 3100 and the light-emitting optical pattern 3210 is formed in a portion of the light-emitting surface 3200 will be described by way of example. This is because when the light-emitting optical pattern 3210 is formed in the entire light-emitting surface 3200, it may be more difficult for the beam pattern formed by the vehicle lamp 1 of the present disclosure to have sufficient brightness.

In this regard, the light-receiving optical patterns 3110 may be formed to extend in the vertical direction and may be arranged in the horizontal direction. The light-emitting optical patterns 3210 may be formed to extend in the horizontal direction and may be arranged in the vertical direction. However, this configuration is merely an example for helping understanding of the present disclosure, and the present disclosure is not limited thereto. The directions in which the light-receiving optical pattern 3110 and the light-emitting optical pattern 3210 extend may be the same as or different from each other, depending on the light distribution characteristics required in the beam pattern to be formed by the lamp 1 for a vehicle of the present disclosure.

In an embodiment of the present disclosure, the light-receiving optical pattern 3110 is formed in the entire light-receiving surface 3100 so that the beam pattern formed by the vehicle lamp 1 of the present disclosure has an appropriate width in the left-right direction and the light beams respectively emitted from the plurality of guiding modules 2100 are mixed with each other, thereby realizing a more uniform brightness of the beam pattern.

In addition, in an embodiment of the present disclosure, the light-emitting optical pattern 3210 may be formed in a portion of the light-emitting surface 3200 so that the beam pattern formed by the vehicle lamp 1 of the present disclosure has a sufficient brightness to secure a field of view.

As described above, the lamp 1 for a vehicle according to the present disclosure may use the light-receiving portions 2111 and 2121 having a high degree of concentration, and the light-emitting portions 2112 and 2122 of the plurality of guiding modules 2100 arranged in a single row, thereby enabling a slimmer form factor.

Although embodiments of the present disclosure have been described with reference to the accompanying drawings, the present disclosure is not limited to the above embodiments, but may be implemented in various different forms. A person skilled in the art may appreciate that the present disclosure may be practiced in other concrete forms without changing the technical spirit or essential characteristics of the present disclosure. Therefore, it should be appreciated that the embodiments as described above are not restrictive in any aspects but merely illustrative.

What is claimed is:

1. A lamp for a vehicle comprising:
a plurality of light sources arranged in a plurality of rows;
a first lens including a plurality of guiding modules, each guiding module being configured to adjust a path of light emitted from each of the plurality of light sources; and
a second lens through which the light emitted from the first lens transmits to form a predetermined beam pattern,
wherein each of the plurality of guiding modules includes:
a light-receiving portion onto which the light emitted from a corresponding light source among the plurality of light sources is incident;
a light-transfer portion that transmits the light incident on the light-receiving portion; and
a light-emitting portion that emits the light received from the light-transfer portion, and
wherein the light-transfer portion includes at least one reflective surface that reflects the light incident on the light-receiving portion so as to cause it to be transmitted to the light-emitting portion.

2. The lamp for the vehicle of claim 1, wherein a central axis of the light-receiving portion is spaced apart in a vertical direction from a central axis of the light-emitting portion.

3. The lamp for the vehicle of claim 1, wherein the plurality of light sources are arranged in a first row and a second row, each of which extends in a left-right direction,
wherein the second row is disposed below the first row, and
wherein the plurality of guiding modules include:
a first guiding module that adjusts a path of the light emitted from each of first light sources belonging to the first row among the plurality of light sources; and
a second guiding module that adjusts a path of the light emitted from each of second light sources belonging to the second row among the plurality of light sources.

4. The lamp for the vehicle of claim 3, wherein the first light sources and the second light sources are arranged in a staggered manner along the left-right direction.

5. The lamp for the vehicle of claim 3, wherein the first guiding module includes:
a first light-receiving portion onto which the light emitted from the first light source is incident;
a first light-transfer portion that transmits the light incident on the first light-receiving portion; and
a first light-emitting portion that emits the light received from the first light-transfer portion,
wherein the second guiding module includes:
a second light-receiving portion onto which the light emitted from the second light source is incident;
a second light-transfer portion that transmits the light incident on the second light-receiving portion; and
a second light-emitting portion that emits the light received from the second light-transfer portion, and
wherein each of the first light-transfer portion and the second light-transfer portion includes:
a first reflective surface that reflects the light incident to each of the first light-receiving portion and the second light-receiving portion and proceeding in a forward direction so as to cause it to proceed substantially in a vertical direction; and
a second reflective surface that reflects the light reflected from the first reflective surface so as to cause it to proceed in the forward direction toward each of the first light-emitting portion and the second light-emitting portion.

6. The lamp for the vehicle of claim 5, wherein a vertical position of a central axis of the first light-receiving portion is higher than a vertical position of a central axis of the first light-emitting portion, and
wherein a vertical position of a central axis of the second light-receiving portion is lower than a vertical position of a central axis of the second light-emitting portion.

7. The lamp for the vehicle of claim 5, wherein at least one of the first reflective surface or the second reflective surface includes a plurality of reflective areas, and
wherein formation angles and/or curvatures of the plurality of reflective areas are different.

8. The lamp for the vehicle of claim 1, wherein the first lens further includes an additional reflective portion that reflects a portion of the light emitted from each of the plurality of guiding modules so as to cause it to proceed to the second lens, thereby allowing the beam pattern to be extended to one side.

9. The lamp for the vehicle of claim 8, wherein the additional reflective portion is formed to extend from a bottom of the light-emitting portion of each of the plurality of guiding modules in a forward direction.

10. The lamp for the vehicle of claim 1, wherein the light-emitting portions of the plurality of guiding modules are arranged in a single row that extends in a direction parallel to rows in which the plurality of light sources are arranged.

11. The lamp for the vehicle of claim 1, wherein both opposing sides of the light emitting portion of at least one of the plurality of guiding modules are formed asymmetrically with each other with respect to a central axis of the light emitting portion.

12. The lamp for the vehicle of claim 1, wherein the beam pattern includes a plurality of pattern areas respectively formed by the plurality of guiding modules, and
wherein an optical pattern is formed in the light-emitting portion of at least one of the plurality of guiding modules to control a corresponding pattern area among the plurality of pattern areas.

13. The lamp for the vehicle of claim 12, wherein an orientation of the optical pattern formed in at least one of the plurality of guiding modules is different from an orientation of the optical pattern formed in at least another of the plurality of guiding modules.

14. The lamp for the vehicle of claim 1, wherein central axes of the light-emitting portions of different guiding modules of the plurality of guiding modules are tilted at different angles with respect to a reference line parallel to an optical axis of the second lens.

15. The lamp for a vehicle of claim 14, wherein the tilting angle of the central axis of the light-emitting portion of the guiding module increases as a lateral spacing between the optical axis of the second lens and the central axis of the light-emitting portion of the guiding module increases.

16. The lamp for a vehicle of claim 1, wherein the light-emitting portions of at least two different guiding modules among the plurality of guiding modules are disposed to be spaced by different distances from respective light sources among the plurality of light sources.

17. The lamp for the vehicle of claim 16, wherein the distances between the light-emitting portion and the respective light source increase as a lateral spacing between the light-emitting portion and an optical axis of the second lens increases.

18. The lamp for the vehicle of claim 1, wherein the second lens includes a light-receiving surface and a light-emitting surface, and
wherein a light-receiving optical pattern is formed in at least a portion of the light-receiving surface, and a light-emitting optical pattern is formed in at least a portion of the light-emitting surface.

19. The lamp for the vehicle of claim 18, wherein the light-receiving optical pattern is formed in the entire light-receiving surface, and the light-emitting optical pattern is formed in a portion of the light-emitting surface.

20. The lamp for the vehicle of claim 18, wherein an orientation of the light-receiving optical pattern is different from an orientation of the light-emitting optical pattern.
